(19) United States
(12) Patent Application Publication
(10) Pub. No.: US 2013/0235583 A1
(43) Pub. Date: Sep. 12, 2013

(54) LIGHT FIXTURE AND LIGHTING MODULE HAVING THE SAME

(71) Applicants: CHIEN-LI CHANG, NEW TAIPEI CITY (TW); I-HSIN TUNG, NEW TAIPEI CITY (TW)

(72) Inventors: CHIEN-LI CHANG, NEW TAIPEI CITY (TW); I-HSIN TUNG, NEW TAIPEI CITY (TW)

(73) Assignee: LIGITEK ELECTRONICS CO., LTD., NEW TAIPEI CITY (TW)

(21) Appl. No.: 13/416,457

(22) Filed: Mar. 9, 2012

(51) Int. Cl. F21V 21/00; F21V 29/00

(52) U.S. Cl. 362/249.02; 362/249.01

(57) ABSTRACT

The instant disclosure relates to a lighting module, which includes at least a pair of light fixtures. Each of the light fixtures has a frame, a light source assembly, and a cover. The frame has a base plate, a first side plate, and a second side plate. The first side plate has a first engaging portion, and the second side plate has a second engaging portion and a plurality of third engaging portions. The two light fixtures are interlocked to one another by the following means: the first engaging portion and the first side plate of one light fixture are engaged to the second engaging portion and the third engaging portions of the other light fixture, respectively.

### BACKGROUND OF THE INVENTION

1. Field of the Invention

The instant disclosure relates to a lighting device; more particularly, to a lighting fixture and a lighting module having the same.

2. Description of Related Art

Because of the advantages associated with light-emitting diodes (LEDs), such as high luminosity, energy saving, and long service life, the LEDS have been used widely with various lighting devices. One of the everyday applications is LED street light. Conventional LED light fixture comprises a housing and a light source. Light is dispersed from the bottom portion of the housing. Whereas another type of LED light comprises a housing, a frame, and a plurality of light sources. The light sources are recessed in the frame.

However, each type of existing LED light has its own efficiency and structural configurations. Therefore, each type of LED light is used for a particular lighting application. To adjust its efficiency, a new mold and electrical circuit have to be provided to manufacture an LED light having adjusted efficiency. Since the molding process requires a high cost, most industrial manufacturers can not afford such spending.

To address the above issues, the inventors strive via industrial experience and academic research to present the instant disclosure, which can effectively improve the limitations described above.

### SUMMARY OF THE INVENTION

To address the above issue, the instant disclosure provides a lighting fixture. The lighting fixture comprises a frame, at least one light source assembly, and a cover. The frame has a first engaging portion, a second engaging portion, and a plurality of third engaging portions. At least one opening is formed on the frame. The light source assembly is recessed within the frame and exposed through the opening. The cover is disposed on the frame and cooperatively define a heat dissipating space for heat dissipation.

The instant disclosure further provides a lighting module. The lighting module comprises at least a pair of light fixtures. Each light fixture includes a frame, at least one light source assembly, and a cover. The frame has a base plate, a first side plate, and a second side plate. The first side plate has a first engaging portion. The second side plate has a second engaging portion and a plurality of third engaging portions. The first engaging portion and the first side plate of one light fixture are engaged to the second engaging portion and the third engaging portions of the other light fixture, respectively.

In cases where the lighting efficiency and physical structures of the light fixture need to be changed, the light fixture and lighting module having the same of the instant disclosure are able to achieve the objectives without making a new mold and an electrical circuit, thus reducing the manufacturing cost. Moreover, the modularized design of the light fixture of the instant disclosure can dissipate heat effectively, is easy to maintain, replace, and adapt to various applications. The light fixture is also energy efficient and environmentally friendly. All of the aforementioned advantages allow the light fixture of the instant disclosure to be used widely both indoors and outdoors, such as in places like sidewalks, courtyards, plazas, freeways, parking structures, sport venues, etc.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1A is a perspective view showing a light fixture of the instant disclosure.

FIG. 1B is a perspective view showing the light fixture of the instant disclosure at a different angle.

FIG. 2 is a schematic view showing a frame of the light fixture of the instant disclosure.

FIG. 3A is an exploded view of a light source assembly for the light fixture of the instant disclosure.

FIG. 3B is an exploded view of another light source assembly for the light fixture of the instant disclosure.

FIG. 4 is a perspective view of yet another light source assembly for the light fixture of the instant disclosure.

FIG. 5A is an exploded view for a lighting module of the instant disclosure.

FIG. 5B is an enlarged view of section A in FIG. 5A.

FIG. 5C is an enlarged view of section B in FIG. 5A.

FIG. 6A is a perspective view showing a street light using the lighting module of the instant disclosure.

FIG. 6B is a perspective view showing another street light using the lighting module of the instant disclosure.

FIG. 7A is a perspective view showing a street light for a third embodiment of the instant disclosure.

FIG. 7B is a perspective view showing a variant of the street light shown in FIG. 7A.

FIG. 8 is an exploded view showing a lighting module for a fourth embodiment of the instant disclosure.

### DETAILED DESCRIPTION OF THE EMBODIMENTS

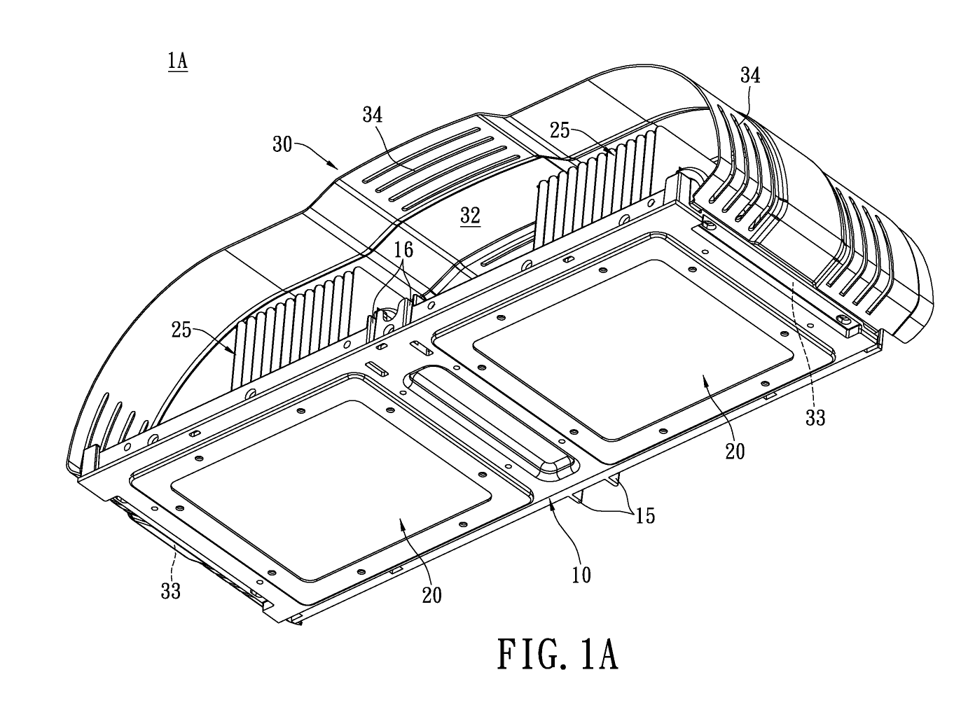

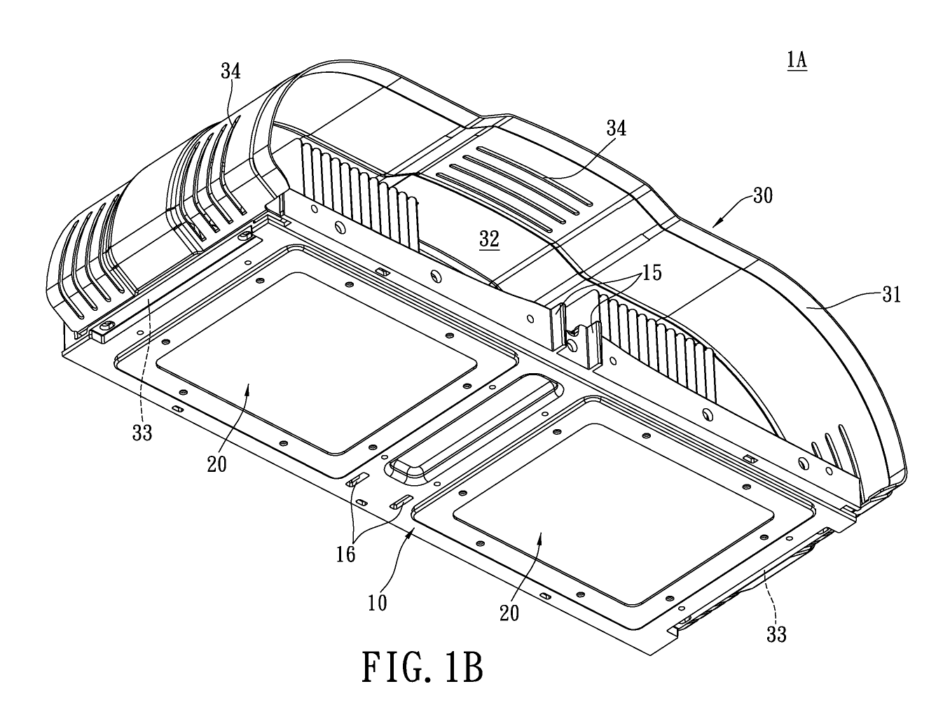

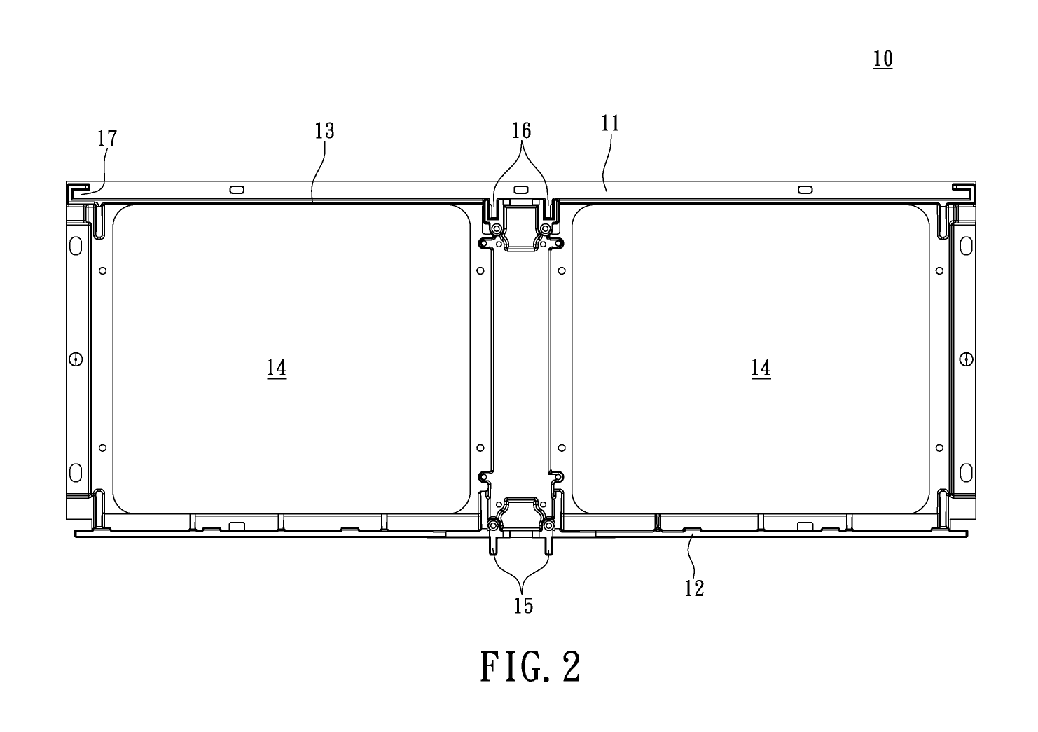

Please refer to FIGS. 1A, 1B and 2, where FIGS. 1A and 1B show a light fixture 1A of the instant disclosure, and FIG. 2 shows a frame 10 of the light fixture 1A. The light fixture 1A comprises the frame 10, at least one light source assembly 20, and a cover 30. At least one opening 14 is formed on the frame 10. The frame 10 has a first engaging portion 15, a second engaging portion 16, and a plurality of third engaging portions 17. The light source assembly 20 is recessed into the frame 10 and exposed through the opening 14. The cover 30 is disposed on the frame 10. Together, the frame 10 and the cover 30 cooperatively define a heat dissipating space 32, to reduce heat build up in the light fixture 1A. Through the first, second, and third engaging portions 15, 16, and 17, two or more light fixtures 1A can be mounted side by side.

More specifically, the frame 10 is substantially U-shaped. As shown in FIG. 2, the frame 10 has a base plate 11, a first side plate 12, and a second side plate 13. The first and second side plates 12 and 13 extend from the opposed side portions of the base plate 11 parallelly toward the same direction. For the instant embodiment, the frame 10 is made of aluminum material, which is light weight and corrosion resistant, but is not limited thereto.

The opening 14 is formed on the base plate 11. The first engaging portion 15 is formed protrudingly about half way along a surface of the first side plate 12. Whereas the second engaging portion 16 is formed concavely about half way along a surface of the second side plate 13. The first and second engaging portions 15 and 16 are sized and configured to structurally complement each other. For example, in the instant embodiment, the first engaging portion 15 has a pair of protruding lips for mating to a pair of notches of the second engaging portion 16. Furthermore, each of the opposed ends of the second side plate 13 extends outwardly in forming the third engaging portion 17. Each of the third engaging portions 17 is an L-shaped retaining slot. It is worth noting the interconnecting means of the light fixture 1A is not limited to the example described above.

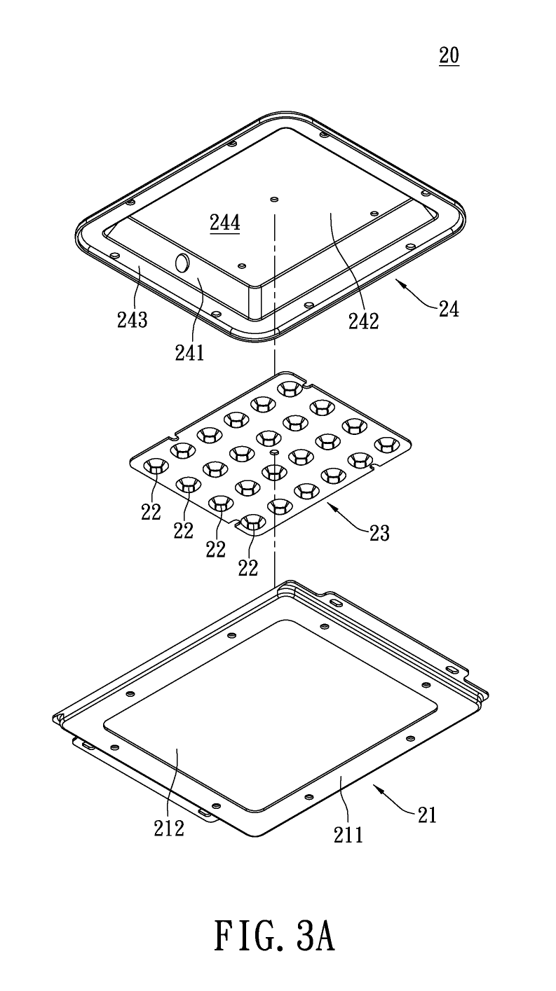

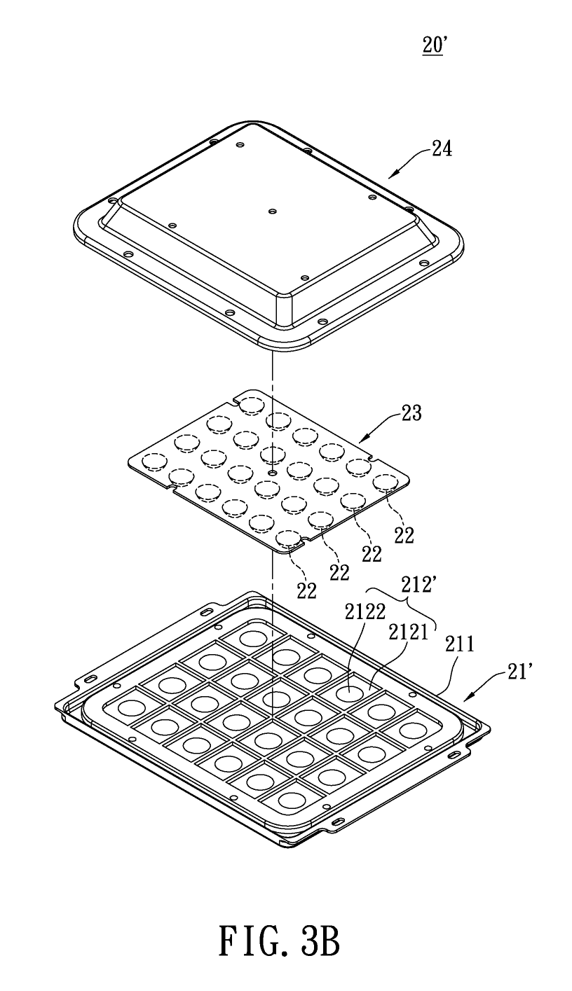

Please refer to FIG. 3A, the light source assembly 20 includes a frame-shaped holder 21, a plurality of light-emitting diodes (LEDs) 22, a circuit board 23, and a base 24. The holder 21 has a first connecting portion 211 and a light-permitting window 212. The window 212 is recessed into the first connecting portion 211. The LEDs 22 are fixed on the circuit board 23 and electrically connected thereto. The base 24 has a plurality of side walls 241, a bottom wall 242, and a second connecting portion 243. The side walls 241 are formed extendingly from the bottom wall 242. The side walls 241 and the bottom wall 242 cooperatively define a receiving space 244. The second connecting portion 243 is formed extendingly from one end of each side wall 241.

The assembling steps of the light source assembly 20 are described hereinbelow. First, the LED-mounted circuit board 23 is disposed in the receiving space 244 of the base 24. Screws (not shown) are then used to fix the circuit board 23 on the base 24 through screw holes formed on the circuit board 23 and the bottom wall 242. Next, screws can be used to secure the holder 21 to the base 24 through screw holes formed on the first connecting portion 211 of the holder 21 and the second connecting portion 243 of the base 24. To prevent moisture, such as rain water, from entering the light source assembly 20, a sealing ring (not shown) can be further included.

Please refer to FIG. 3B, which shows an alternate light source assembly denoted by the numeral 20′. For the light source assembly 20′, a window 212′ of a holder 21′ includes a plurality of customized optical lenses 2121. Each of the optical lenses 2121 has a curved central portion 2122. Each of the central portions 2122 is aligned to a particular LED 22. Thus, when the light source assembly 20′ is in use, the light emitting from the LEDs 22 is redirected by the light input and output surfaces of the central portions 2122 to accomplish different lighting effects.

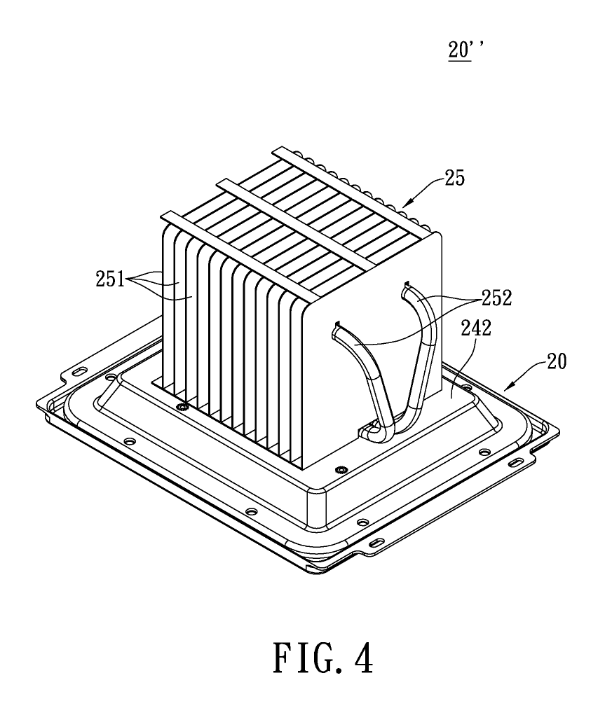

Please refer to FIG. 4 in conjunction with FIGS. 3A and 3B. The aforementioned light source assembly 20, 20′ can further be provided with a heat sink 25. The heat sink 25 is disposed on the outer surface of the bottom wall 242. Structurally, the heat sink 25 has a plurality of heat dissipating fins 251 and a plurality of tube-like heat-conducting members 252. The heat dissipating fins 251 and the heat-conducting members 252 are made of thermally conductive material. The heat dissipating fins 251 are spaced apart from each other and arranged on the outer surface of the bottom wall 242. Each of the heat-conducting members 252 is U-shaped and arranged on the outer surface of the bottom wall 242. Each of the heat-conducting members 252 is also connected to every heat dissipating fins 251. Thus, when the light source assembly having the heat sink 25 is in use, as denoted by the numeral 20″ in FIG. 4, the generated heat is guided by the heat-conducting members 252 from the base 24 to the heat dissipating fins 251. Since the heat dissipating fins 251 have larger surface areas, thus heat can be dissipated more quickly to the ambient.

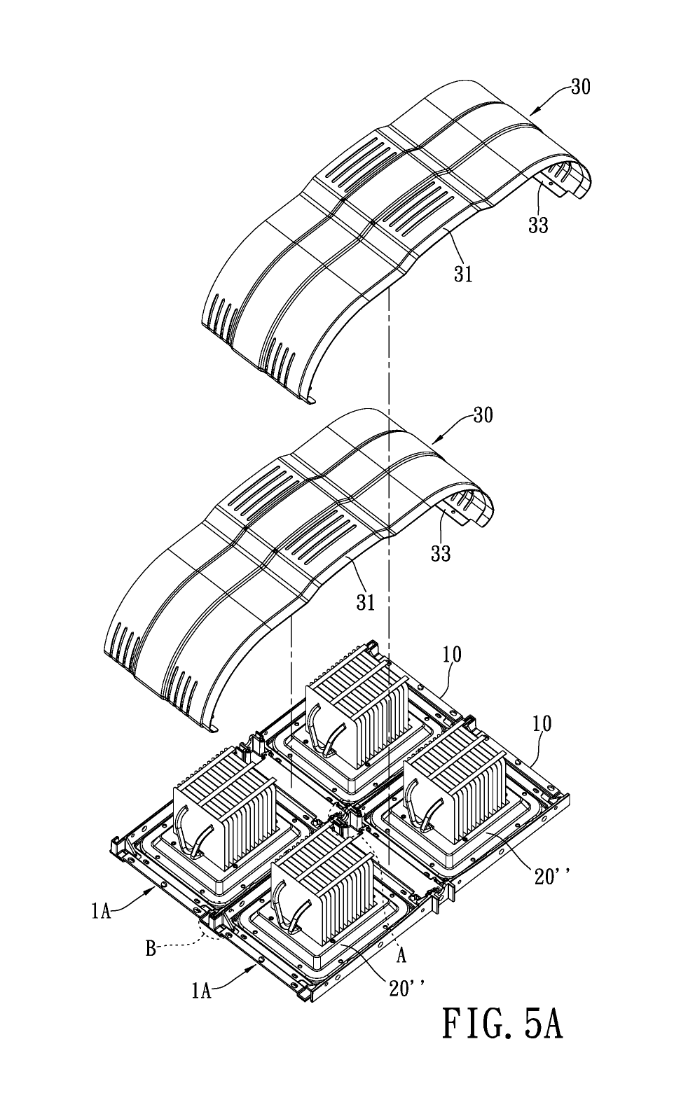

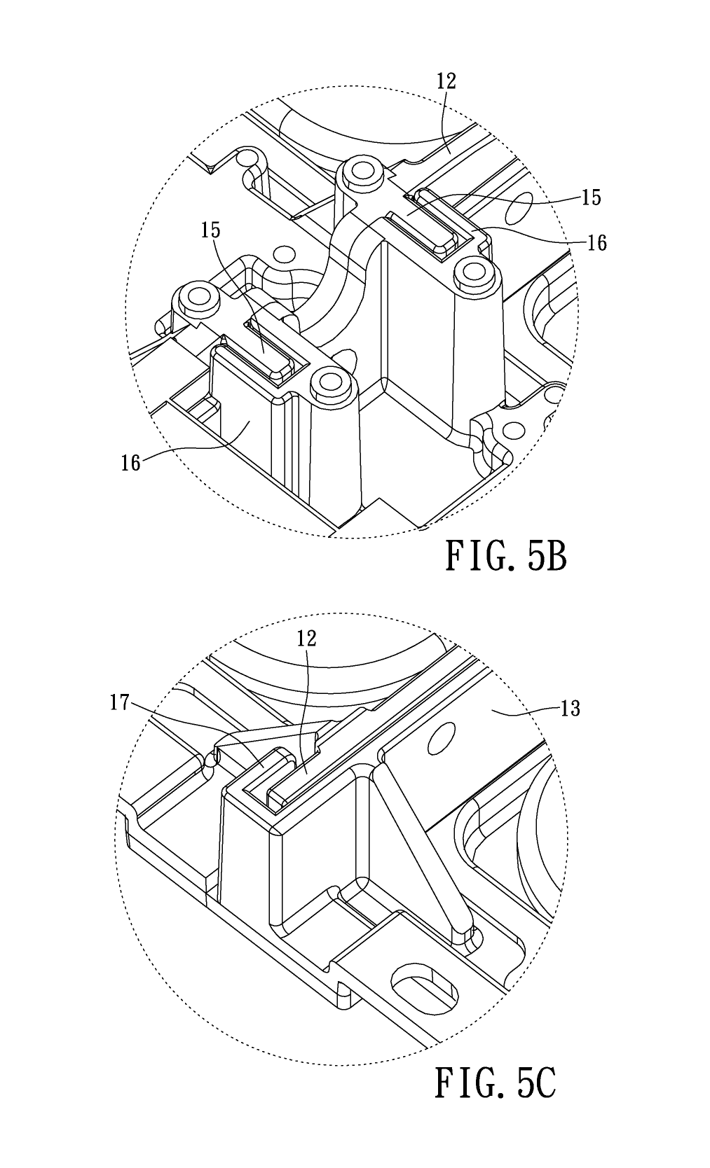

Please refer to FIG. 5A, in conjunction with FIGS. 1A, 1B, and 2. More specifically, the cover 30 is constructed like a half shell with a sheet metal or plastic material. A stepped lip portion 31 projects outwardly from an edge of the cover 30, for reasons that will be discussed hereinafter. A third connecting portion 33 is further formed extendingly at each of the two opposed ends of the cover 30. The third connecting portions 33 are used for mating to the base plate 11 of the frame 10, thus forming the heat dissipating space 32. In the case of the heat sink-mounted light source assembly 20″, the heat sink 25 is accommodated by the heat dissipating space 32. Furthermore, a plurality of elongated holes 34 is formed on the cover 30 for heat dissipation. When the light source assembly 20″ is in use, the hot air adjacent to the heat sink 25 is guided by the cover 30 and vented to the ambient through the holes 34.

The assembling process of the light fixture 1A is discussed below. First, screws can be used to secure the light source assembly 20, 20′, and 20″ to the frame 10 through the screw holes formed on the holder 21 and 21′ and the base plate 11 of the frame 10. Thus, the light source assembly 20, 20′, 20″ is exposed through the opening 14 of the frame 10. Next, screws can be used to secure the cover 30 to the frame 10 through the screw holes formed on the third connecting portions 33 of the cover 30 and the base plate 11 of the frame 10. The cover 30 shields the light source assembly 20, 20′, and 20″ and its heat sink 25 from direct contact with the rain water and dust.

It is worth noting, for the light fixture 1A of the instant disclosure, the shape, structural configuration, and quantity of the light source assembly 20, 20′, and 20″ are not restricted. Depending on the desired visual effect or lighting efficiency, the shape, structural configuration, and the quantity of the light source assembly 20, 20′, and 20″ can be varied accordingly. Relatedly, the shape, structural configuration, and the number of openings 14 of the frame 10 must be compatible to the light source assembly 20, 20′, and 20″.

When using the light fixture 1A outdoors, the number of light fixtures 1A can be varied, depending on the required lighting efficiency. The assembling process of at least two light fixtures 1A is discussed below. As shown in FIGS. 5B and 5C, when connecting a pair of light fixtures 1A, the first engaging portion 15 and the first side plate 12 of one light fixture 1A is tightly snapped into the second engaging portion 16 and the third engaging portion 17 of the other light fixture 1A, respectively. Moreover, the lip portion 31 of one light fixture 1A is mated to the cover 30 of the other light fixture 1A.

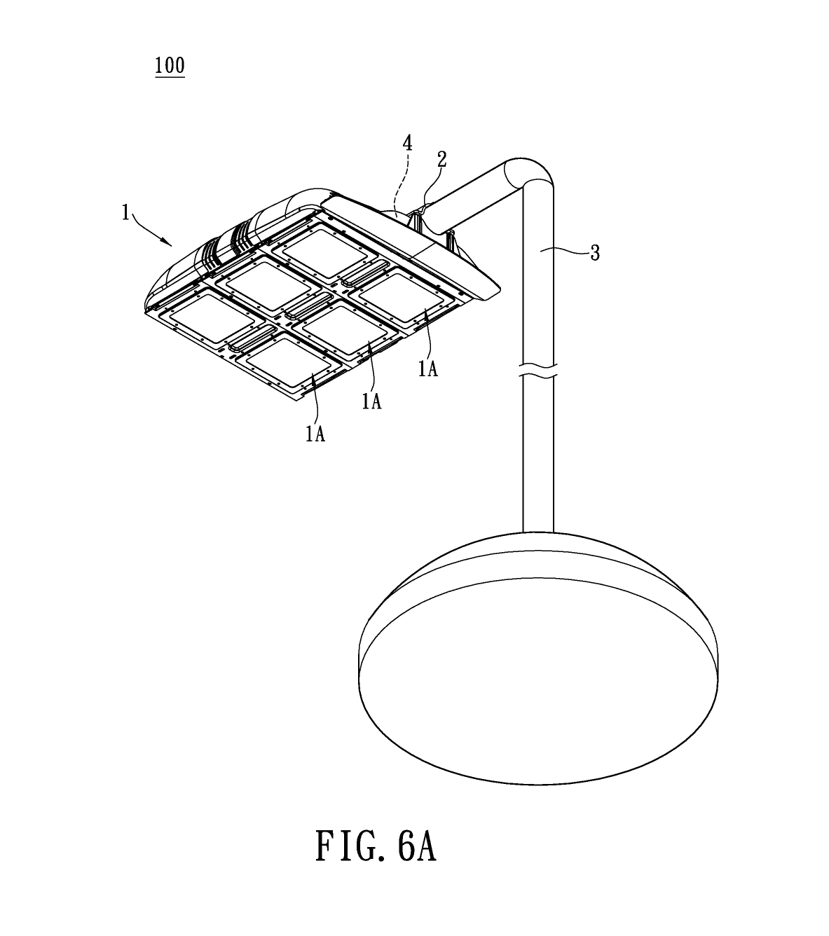

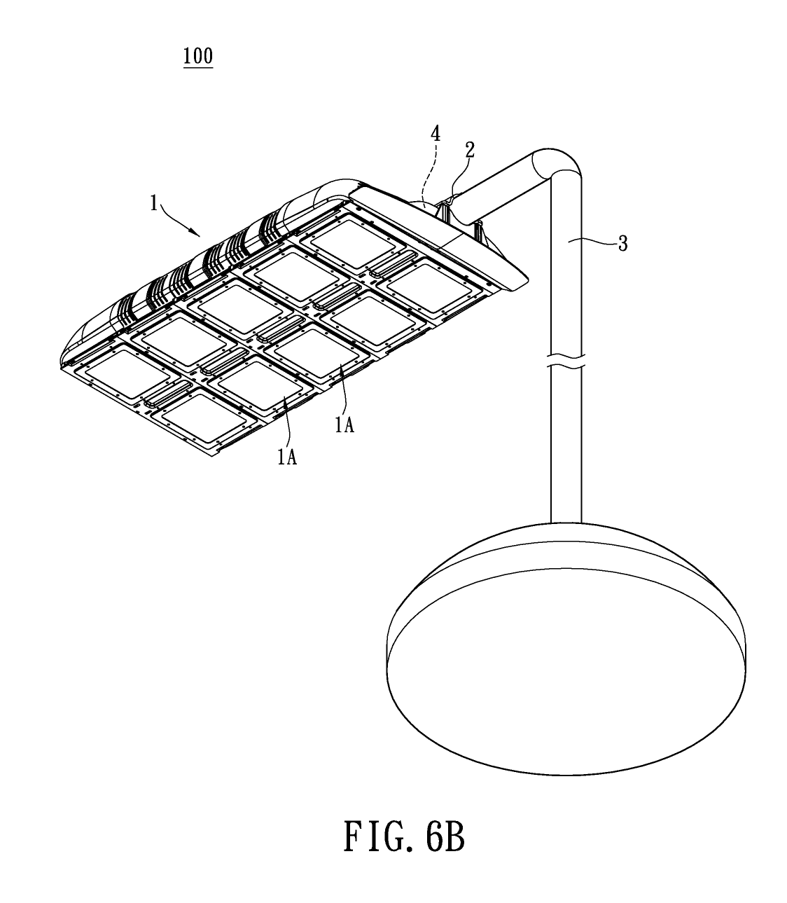

Please refer to FIGS. 6A and 6B in conjunction with FIG. 5A. FIG. 6A shows a street light 100 using a lighting module 1, where the lighting module 1 is constructed with a plurality of light fixtures 1A of the instant disclosure. Whereas FIG. 6B shows a variant of the street light 100. Depending on the lighting requirement, the number of light fixtures 1A can be varied. In practice, the lighting module 1 can be widely used in places such as public squares, sidewalks, highways, airports, and places where a high lighting efficiency is required. The street light 100 further includes a mounting bracket 2 and a light post 3. The mounting bracket 2 has a pivot member 4 for connecting pivotally to the cover 30 of selected light fixture 1A. Thus, the lighting module 1 of the street light 100 can be adjusted angularly to change the light projection area. The application range of the street light 100 is greatly broadened.

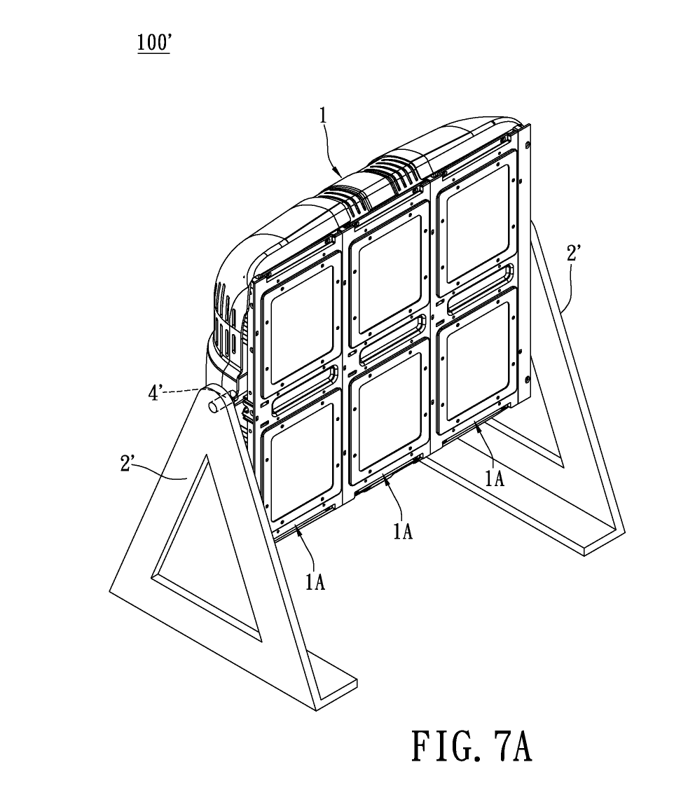

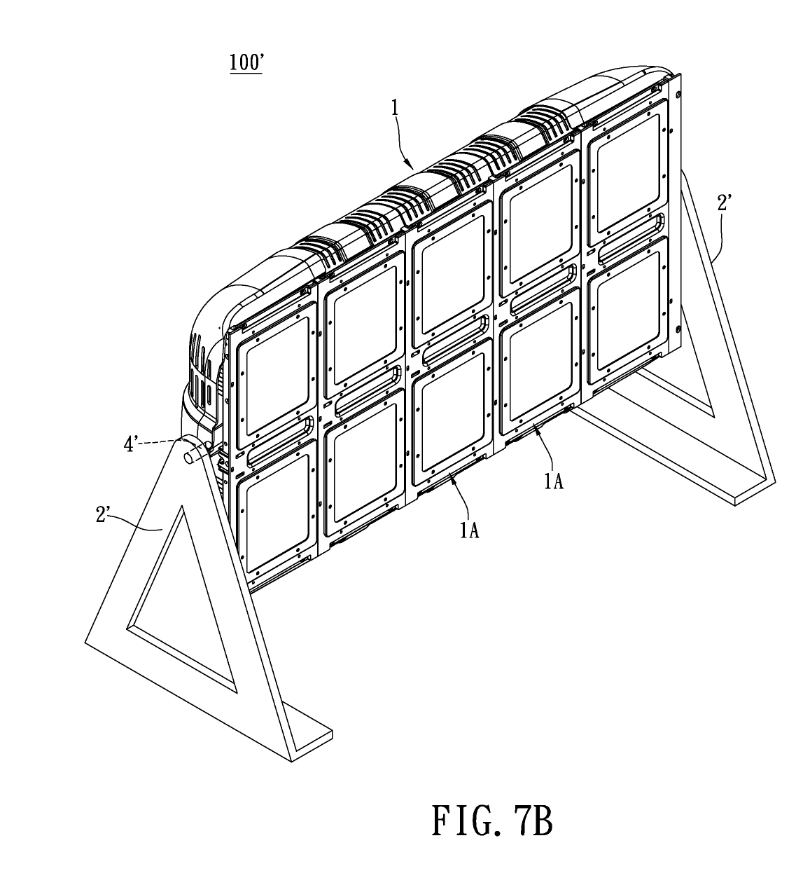

Please refer to FIGS. 7A and 7B in conjunction with FIG. 5A. FIG. 7A shows a street light 100′ using the lighting module 1, and FIG. 7B shows a variant of the street light 100′ shown in FIG. 7A. Similarly, the number of light fixtures 1A of the lighting module 1 can be varied. Unlike the previous embodiment, the street light 100′ has a pair of mounting brackets 2′. Each mounting bracket 2′ is pivotally connected to the lighting module 1 as a support stand. Each mounting bracket 2′ has a pivot member 4′, such as a pivot pin. Thus, the lighting module 1 of the street light 100′ can be adjusted angularly to change the light projection area. For example, the street light 100′ can be used in construction sites or for large scale stage lighting applications.

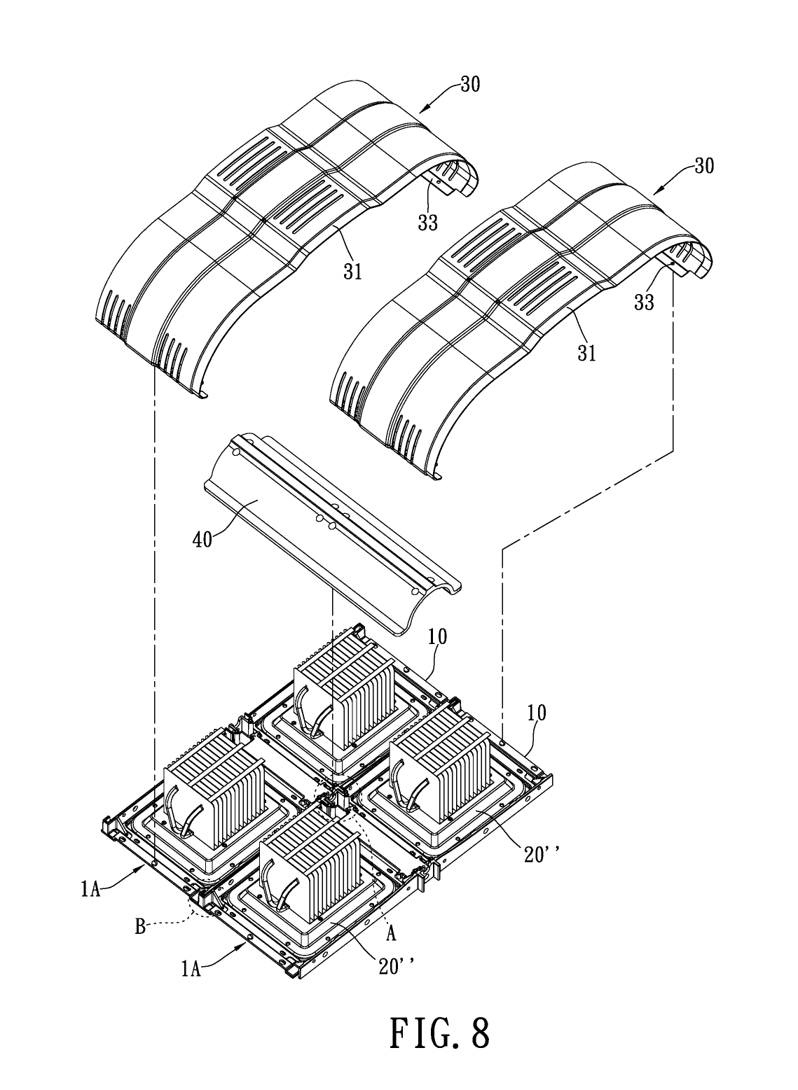

Please refer to FIG. 8 in conjunction with FIG. 5A. FIG. 8 shows a lighting module 1′ of the instant disclosure. The lighting module 1′ further has a mounting member 40. When the lighting module 1′ is used in applications where high lighting efficiency is required, the mounting member 40 can be fixed to the frame 10 of each light fixture 1A by fastening members such as screws. Thus, besides using the interconnecting means of employing the engaging portions by the light fixtures 1A as previously described, the addition of the mounting member 40 provides further structural stabilization for the lighting module 1′.

Moreover, since the mounting member 40 is formed of extruded aluminum, the size of the mounting member 40 can be adjusted depending on the lighting requirement. Please note that FIG. 8 is only used to illustrate the connecting means between the mounting member 40 and the light fixtures 1A, where the size of the mounting member 40 and the number of the light fixtures 1A are not restricted.

In view of the above, the instant disclosure has the following advantages. The light fixture can be mass produced using a standardized process to simplify the manufacturing process and ensure the product quality. The modularized light fixture has excellent heat dissipating capability, besides being easy to maintain, replace, and expand in numbers. The light fixture is also energy efficient, environmental friendly, and cost effective without the needs to make new molds and electrical circuit. Based on the lighting requirement, the number of light fixtures for the lighting module can be easily adjusted, where the lighting module can be widely used indoors and outdoors.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A lighting module (1), comprising:
at least a pair of light fixtures (1a), wherein each light fixture has a frame (10), at least one light source assembly (20), and a cover (30);
wherein the frame has a base plate (11), a first side plate (12), and a second side plate (13), wherein the first side plate has a first engaging portion (15), while the second side plate has a second engaging portion (16) and a plurality of third engaging portions (17), wherein the first engaging portion and the first side plate of one light fixture is engaged to the second engaging portion and the third engaging portions of the other light fixture, respectively.

2. The lighting module of claim 1, wherein the first engaging portion is formed protrudingly about half way along a surface of the first side plate, the second engaging portion is formed concavely about half way along a surface of the second side plate, and each of the opposed ends of the second side plate extends outwardly in forming the third engaging portion.

3. The lighting module of claim 2, wherein the first engaging portion has a pair of protruding lips, the second engaging portion has a pair of notches for engaging the protruding lips, and each of the third engaging portions is an L-shaped retaining slot for engaging the first side plate of the frame.

4. The lighting module of claim 1, wherein a stepped lip portion (31) is projected outwardly from an edge of the cover.

5. The lighting module of claim 1, further comprising a mounting member (40) fixed to the frames of the light fixtures.

6. A light fixture (1a), comprising:
a frame (10) having at least one opening (14) formed thereon, a first engaging portion (15), a second engaging portion (16), and a plurality of third engaging portions (17);
at least one light source assembly (20) recessed into the frame and exposed through the opening; and
a cover (30) disposed on the frame and cooperatively form a heat dissipating space (32).

7. The light fixture of claim 6, wherein the frame is U-shaped and having a base plate, a first side plate, and a second side plate, and wherein the first and second side plates extend from opposed edge portions of the base plate.

8. The light fixture of claim 7, wherein the first engaging portion is formed protrudingly about half way along a surface of the first side plate, the second engaging portion is formed concavely about half way along a surface of the second side plate, and each of the opposed ends of the second side plate extends outwardly in forming the third engaging portion.

9. The light fixture of claim 8, wherein the first engaging portion has a pair of protruding lips, the second engaging portion has a pair of notches for engaging the protruding lips, and each of the third engaging portions is an L-shaped retaining slot for engaging the first side plate of the frame.

10. The light fixture of claim 6, wherein the light source assembly includes a holder (21), a plurality of light-emitting diodes (LEDs) (22), a circuit board (23), and a base (24).

11. The light fixture of claim 10, wherein the holder has a first connecting portion (211) and a light-permitting window (212) recessed therein.

12. The light fixture of claim 10, wherein the base has a plurality of side walls (241), a bottom wall (242), and a second connecting portion (243), wherein the side walls extend from the side portions of the bottom wall and cooperatively forming a receiving space (244), and wherein the second connecting portion is extended from one end of each side wall.

13. The light fixture of claim 12, wherein the light source assembly further includes a heat sink (25), wherein the heat sink has a plurality of heat dissipating fins (251) and tube-shaped heat conducting members (252), wherein the heat dissipating fins are spaced apart from each other and disposed on the outer surface of the bottom wall, and wherein the tube-shaped heat conducting members are U-shaped and connected to each heat dissipating fins.

14. The light fixture of claim 6, wherein a stepped lip portion (31) is projected outwardly from an edge of the cover.

15. The light fixture of claim 6, further comprising a mounting member (40) connected to the frame.
